(19) United States
(12) Patent Application Publication
(10) Pub. No.: US 2017/0269959 A1
(43) Pub. Date: Sep. 21, 2017

(54) METHOD, APPARATUS AND SYSTEM TO SEND TRANSACTIONS WITHOUT TRACKING

(71) Applicant: Intel Corporation, Santa Clara, CA (US)

(72) Inventors: Ishwar Agarwal, Hillsboro, OR (US); Eric R. Wehage, Tenino, WA (US); David M. Lee, Portland, OR (US); Swadesh Choudhary, Santa Clara, CA (US); Rahul Pal, Bangalore (IN)

(21) Appl. No.: 15/070,146

(22) Filed: Mar. 15, 2016

(51) Int. Cl. G06F 9/46; G06F 13/40; G06F 13/16

(52) U.S. Cl. CPC G06F 9/466; G06F 13/16; G06F 13/4068

(57) ABSTRACT

In one embodiment, an apparatus comprises: an encoder to receive a non-posted transaction from a requester and encode information of the non-posted transaction into an encoded transaction identifier having a predetermined root bus identifier reserved for non-posted transactions; and a first transmitter to send the non-posted transaction including the encoded transaction identifier to a fabric, to enable the non-posted transaction to be routed to a destination. Other embodiments are described and claimed.

### TECHNICAL FIELD

Embodiments relate to communicating transactions in a computer system.

### BACKGROUND

Modern processors can be used to build highly scalable computer systems such as server computers that are meant for high throughput computing segments. In such systems, input/output (IO) performance (in terms of bandwidth and latency) can be particularly challenged as the number of cores, memory bandwidth and IO configurations increase.

### BRIEF DESCRIPTION OF THE DRAWINGS

FIG. 1 is a block diagram of a multi-socket computer system in accordance with an embodiment of the present invention.

FIG. 2 is a block diagram of a portion of a system in accordance with an embodiment.

FIG. 3 is a graphical illustration of a transaction identifier in accordance with an embodiment.

FIG. 4A is a block diagram of a representative hardware circuit for encoding non-posted transactions in accordance with an embodiment.

FIG. 4B is a block diagram of a representative hardware circuit for decoding completions in accordance with an embodiment.

FIG. 5 is a flow diagram of a method in accordance with an embodiment of the present invention.

FIG. 6 is a flow diagram of a method in accordance with another embodiment of the present invention.

FIG. 7 is a high level block diagram of a system in accordance with an embodiment.

FIG. 8 is a high level block diagram of a multi-socket server system in accordance with an embodiment.

FIG. 9 is an embodiment of a fabric composed of point-to-point links that interconnect a set of components.

FIG. 10 is an embodiment of a system-on-chip design in accordance with an embodiment.

FIG. 11 is a block diagram of a system in accordance with an embodiment of the present invention.

### DETAILED DESCRIPTION

In the following description, numerous specific details are set forth, such as examples of specific types of processors and system configurations, specific hardware structures, specific architectural and micro-architectural details, specific register configurations, specific instruction types, specific system components, specific measurements/heights, specific processor pipeline stages and operation etc. in order to provide a thorough understanding. It will be apparent, however, to one skilled in the art that these specific details need not be employed to practice a given embodiment. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system have not been described in detail in order to avoid unnecessarily obscuring the illustrated embodiments.

Although the following embodiments may be described with reference to specific integrated circuits, such as of computing platforms or microprocessors, other embodiments are applicable to other types of integrated circuits and logic devices. Similar techniques and teachings of embodiments described herein may be applied to other types of circuits or semiconductor devices. For example, the disclosed embodiments are not limited to server or desktop computer systems, and may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it is a singular purpose of most fabrics to provide highest possible performance with maximum power saving. Below, a number of interconnects are discussed, which would potentially benefit from embodiments described herein.

In various embodiments, a root complex or other circuit within a system may be configured to perform encoding of received non-posted transactions without providing a tracking structure to store information regarding the non-posted transactions, while still providing correct handling of received completions for these transactions. As will be described herein, in embodiments one or more root port buses may be reserved by the root complex or other circuit for use in connection with such non-posted transactions to enable their encoding and processing without the need to leverage tracking structures within the root complex or other circuit. Understand that a non-posted transaction is a given request such as a read or write request where a response is in the form of a completion (such as data response to a read request). In contrast, a posted transaction is a given request such as a write request in which the requester does not wait for any response.

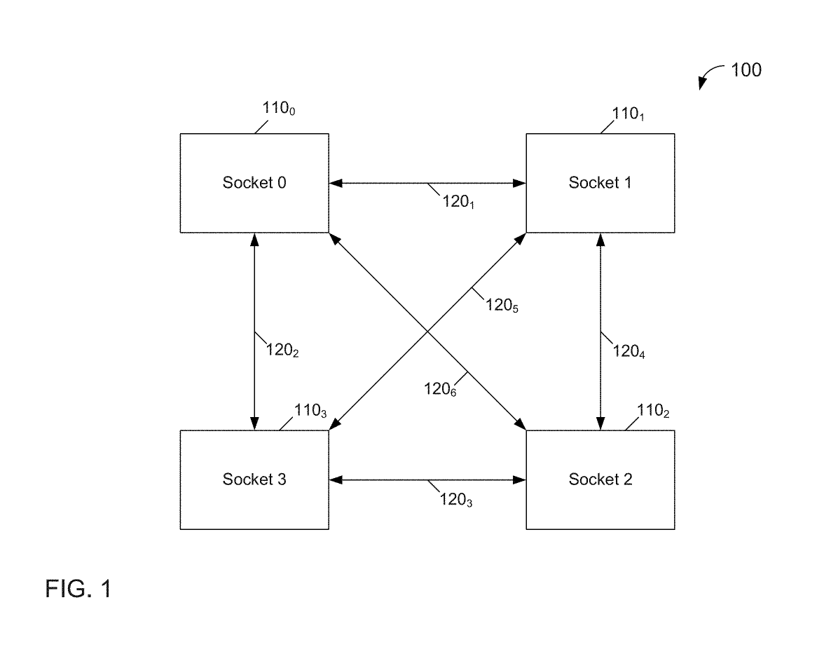

While embodiments are applicable to many different types of systems, one embodiment may be used in connection with a multi-socket computing system such as a server computer. Referring now to FIG. 1, shown is a block diagram of a multi-socket computer system in accordance with an embodiment of the present invention. As shown in FIG. 1, system 100 may be a server computer including a plurality of sockets 110₀-110₃. In embodiments, each socket may be implemented as a multicore processor. Such multicore processor may include a desired number of cores, e.g., 4, 8, 16 or more cores. In addition, each socket 110 includes additional processing circuitry, including uncore circuitry, cache memories, interface circuitry and so forth.

To enable communication with various endpoints (not shown for ease of illustration in FIG. 1) coupled to given sockets 110, each socket may include one or more root complexes having circuitry to communicate with such endpoints according to a given communication protocol. In one embodiment, the communication protocol may be in accordance with a given Peripheral Component Interconnect Express (PCIe) specification (such as the PCIe Base Specification version 2.0 (published Jan. 17, 2007)), herein “a PCIe specification.” As illustrated in FIG. 1, sockets 110 may be coupled in a fully-connected configuration, in that each socket 110 is directly coupled to each other socket by a corresponding interconnect 120₁-120₆. In embodiments, interconnects 120 may be implemented as UniPath interconnects (UPIs), although other interconnects such as Quick Path Interconnect (QPI) interconnections also are possible.

As will be described further below, each socket 110 may typically include one to n PCIe root ports (RP), where n can range between 1 to around 20 in an example system. Each root port in turn can be connected to a PCIe fabric of switches, which can then be connected to a plurality of end points, e.g., 1 to m PCIe end points (EP), where m is only limited by PCIe enumeration and Bus/Device/Function ranges.

Each core on any socket 110 is configured to communicate with any PCIe EP, anywhere within a system, regardless of whether that EP resides on the same socket or on a different socket. Such transactions are core-initiated transactions. Further, each PCIe EP is configured to communicate with any other PCIe EP, anywhere within the system, regardless of whether the destination EP happens to reside below the same RP, on another RP within the same socket or on a completely different socket altogether. Such transactions are referred to as peer-to-peer transactions. Of course while shown with a socket-centric view in FIG. 1, a given server may include many additional components, including memories, storage, communication circuitry, power delivery circuitry, network interface circuitry and so forth.

Enabling many-to-many communication across PCIe, intra-socket and inter-socket fabrics can represent a massive scaling challenge, especially since each fabric has different link and protocol layer semantics. One of the manifestations of this scaling problem is tracking non-posted requests as they flow through heterogeneous fabrics.

Non-posted transactions (core-initiated or peer-to-peer) have an associated completion that is to be routed back to the transaction source. Since there may be multiple heterogeneous fabrics through which a completion may travel, routing information available in a conventional PCIe completion packet is insufficient. As a result, a conventional root complex maintains tracking structures having an entry allocated when a downstream non-posted transaction is sent. When an upstream completion is received at the root complex, it is matched against the pre-allocated entry to look up the routing information used to route the completion back to the source. However, the size of this tracking structure becomes a source of significant performance bottleneck since it limits the number of outstanding non-posted transactions at a time. Scaling the size of this structure is limited by constraints on area, timing, and power.

As described above, embodiments may eliminate the need for tracking structures in these bridging structures and remove associated bandwidth bottlenecks. Such bottlenecks may occur in a partitioned global address space programming model, which has a highly distributed address space across multiple nodes, in turn leading to high bandwidth allocations of non-posted transactions across a PCIe system. Another example is in cases where large dynamic data structures reside in host memory, leading to high throughput requirements on non-posted traffic.

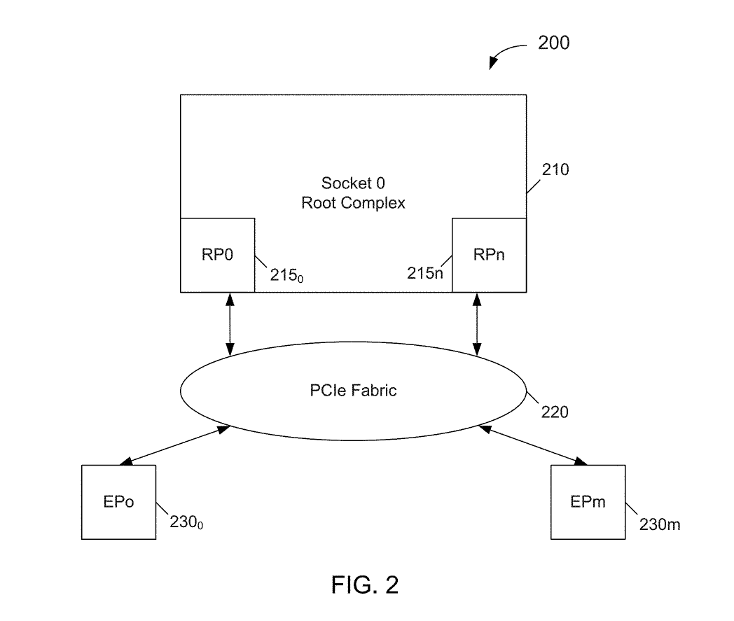

Referring now to FIG. 2, shown is a block diagram of a portion of a system in accordance with an embodiment. More specifically, in system 200 a root complex 210 is provided. Such root complex may be implemented within a representative socket or other integrated circuit and includes a plurality of root ports 215₀-215ₙ. As further illustrated, root complex 210 couples via a fabric 220, which in an embodiment may be a PCIe fabric, to a plurality of endpoints 230₀-230ₘ. Each such endpoint 230 may be implemented as a given peripheral device or component within such peripheral device.

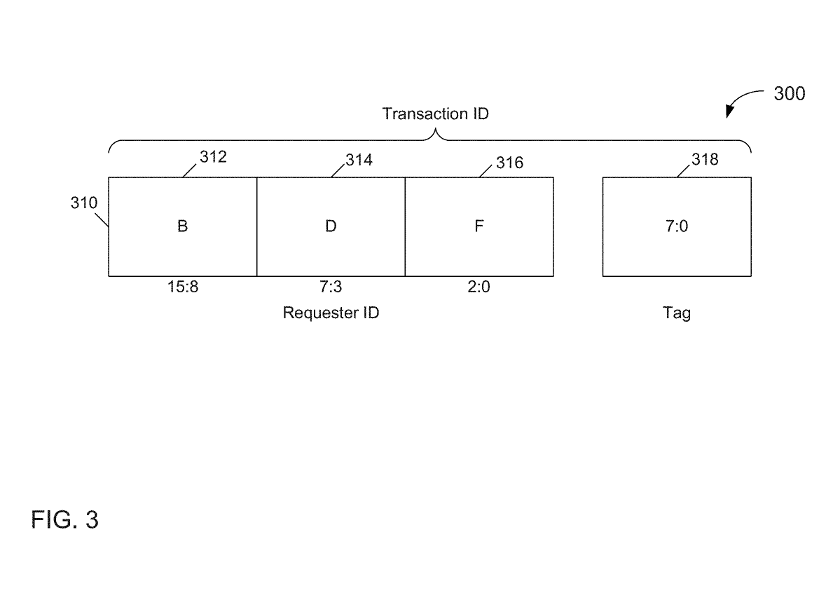

Referring now to FIG. 3, shown is a graphical illustration of a transaction identifier (transaction ID) that provides for encoding of a non-posted transaction in accordance with an embodiment. As illustrated in FIG. 3, transaction ID 300 includes constituent components, namely a requester ID 310 and a tag 318 as in accordance with a PCIe specification. As illustrated, requester ID 310 itself is formed of constituent components or fields, including a bus field 312, a device field 314 and a function field 316.

The enhanced non-posted transaction handling described herein may be referred to as “fire-and-forget,” as downstream PCIe non-posted requests can be sent without the need to maintain tracking structures to route completions back to source, irrespective of where the source resides.

To this end, routing information may be encoded directly in standard PCIe headers. Note that requester ID and tag fields of a transaction ID of a PCIe header are guaranteed to be returned back unchanged with the completion. When the root complex receives a completion, it can use the requester ID and tag to route the completion back to source using a given algorithm.

As such, embodiments, may completely remove tracking structure size-based limitations on PCIe downstream non-posted transaction bandwidth, and provide additional information for an error handler and debug software to determine the source of the transaction to a finer granularity.

In conventional PCIe techniques, the 16-bit requester ID is uniquely assigned to each PCIe function. In turn, the tag field is an 8-bit field generated by each requester and is unique for all outstanding requests that require a completion for that requester. Using an embodiment to perform fire-and-forget, a rule codified in a PCIe specification is leveraged, in that receivers/completers return the transaction ID unmodified with completions for non-posted requests.

As such, embodiments may use up to 24 bits of information to encode internal processor fabric routing information. However, not all 24 bits can be used as is. This is so, as completions are route-by-ID packets on the PCIe fabric. That means the completion uses the requester ID to find its way back to the root port. An arbitrary encoding that overloads this field will break this routing. In addition, the requester ID used by the root port is to be unique in the PCIe system to prevent conflicts and incompatibilities with drivers and OS which rely on them. Finally, the encoded requester ID is to belong to PCIe enumerated functions to present a compliant view to any debug or error handling software to which they might be exposed.

As a result, a new PCIe root bus may be provisioned. This bus belongs to the root complex and is declared to the OS as a host bridge bus by BIOS through an Advanced Configuration and Power Interface (ACPI) operation. All devices and functions belonging to this root bus will be a ‘host bridge class code’ device, which means that the OS will not attempt to load a driver for these functions. Embodiments herein refer to this reserved, predetermined root bus as a fire and forget (FAF) root bus. PCIe configuration headers for all functions within the FAF root bus may be implemented in hardware for PCIe compliance, in embodiments.

In this way, all 256 possible functions below the FAF root bus may be used, since these functions are guaranteed to be non-overlapping. Thus, 8 bits of device (5 bits) and function (3 bits) can be used in a custom manner to encode non-posted transactions. Together with 8 bits of the tag field, 16 bits of information can be used for completion routing within the fabric. These 16 bits can be used in a processor-specific manner. As such, the requester ID may be overloaded with encoding information via this reserved root bus, which provides 256 different requester IDs for use.

One possible encoding scheme is shown below in Table 1.

TABLE 1
Core-Initiated Request
To encode up to 8 Sockets - 3 bits (S[2:0])
To encode up to 64 Cores - 6 bits (C[5:0])
To encode up to 64 Core's Tracking Structure - 6 bits (CTS[5:0])
To differentiate between Core Initiated & P2P - 1 bit (I)
This may be encoded as such:

| | | |
|---|---|---|
| Device | Function | Tag |
| I, S[2:0], C[5] | C[4:2] | C[1:0], CTS[5:0] |

Peer-to-Peer Request
To encode up to 8 Sockets - 3 bits (S[2:0])
To encode up to 32 Root Ports - 5 bits (RP[4:0])
To encode up to 128 Root Complex's Tracking Structure - 7 bits
(RPTS[6:0])
To differentiate between Core Initiated & P2P - 1 bit (I)
This may be encoded as such:

| | | |
|---|---|---|
| Device | Function | Tag |
| I, S[2:0], RP[4] | RP[3:1] | RP[0], RPTS[6:0] |

The above example shows a configuration where non-posted traffic from up to 8 sockets, 64 cores and 32 root ports can be encoded. The 16 bits of routing information can be encoded within the Device, Function and Tag fields in an implementation specific manner. If more than 16 bits are required for internal processor routing, more than one FAF root bus can be enumerated. For example, if 18 bits are required, four FAF root busses can be enumerated through the same mechanism as described above. The two least significant bits of the 8 bit bus number can then be used to encode routing information as well. Note that such one or more FAF root busses reserved for non-posted transactions and associated with the root complex may be in addition to another root bus identifier for the root complex, which may be used in connection with posted requests.

Additionally, since the transaction ID now contains fine-grained information on the originator of the transaction (including detailed source information such as tracking structure locations), debug and error handling software may more precisely determine the source of the transaction, which can be useful for error isolation and recovery actions.

Using an embodiment, instead of communicating a fixed B/D/F (usually, 0/0/0) as part of a transaction identifier for a core-initiated non-posted transaction, a large spread of Device/Function values may be used for multiple such requests, with a constrained set of bus values (e.g., a single or limited amount of bus values).

Note that the encoding of non-posted transactions as discussed herein can be implemented in different embodiments by hardware, software, and/or firmware, and/or combinations thereof. In one particular embodiment, hardware circuitry or other hardware logic may be implemented within root ports or other locations within root complexes or other circuitry within a PCIe-based system to perform encoding and decoding of non-posted transactions as discussed herein.

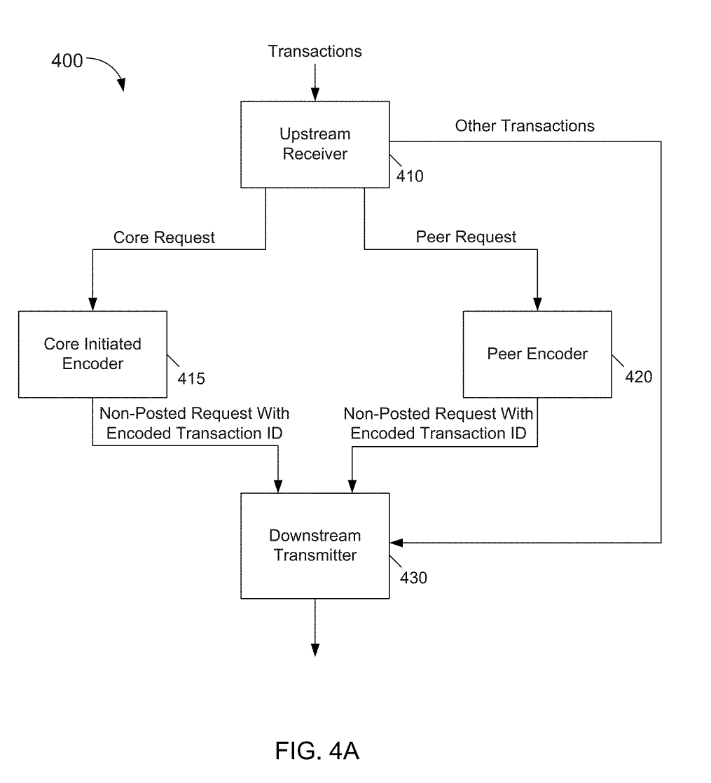

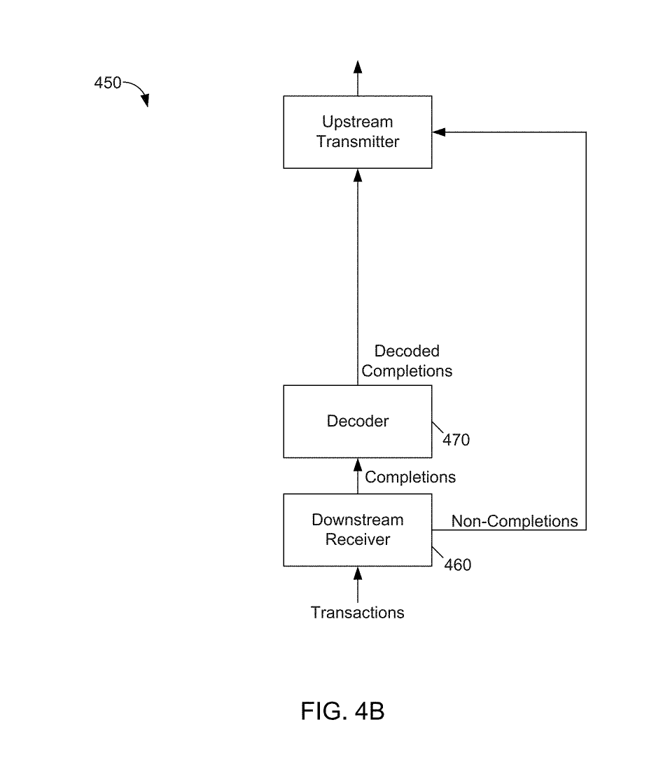

Referring now to FIG. 4A, shown is a block diagram of a representative hardware circuit for encoding non-posted transactions in accordance with an embodiment. As illustrated, encoder circuit 400 may be implemented within a root port and configured to handle incoming non-posted transactions with the encoding described herein. More specifically, incoming requests are received by an upstream receiver 410 configured to receive transactions from an upstream agent, such as core-initiated transactions, peer-initiated transactions or so forth. In some cases, upstream receiver 410 may be configured to identify a non-posted transaction received among various types of incoming transactions and direct it accordingly depending on whether it is a core-initiated request or a peer-initiated request. Upstream receiver 410 may direct transactions other than non-posted transactions (e.g., posted transactions) via a bypass path to a downstream transmitter 430.

For a non-posted transaction, upstream receiver 410 may parse the request to determine whether it is a core-initiated request or a peer-initiated request and direct the request accordingly to either a core-initiated encoder 415 or a peer encoder 420. In various embodiments, encoders 415 and 420 may be configured to encode a non-posted transaction as described herein to include a predetermined (reserved) root bus within the transaction ID of the request so that it can be handled without providing a tracker structure entry for this transaction to handle its completion. Encoders 415 and 420 may further encode information of the incoming non-posted transaction into one or more (and typically two or more) of device and function fields, and a tag of the transaction ID. In an embodiment, encoders 415 and 420 may include logic gates, combinational logic, and/or other circuitry to effect an encoding of a transaction identifier as above in Table 1 (for example).

As further illustrated, encoders 415 and 420 couple to downstream transmitter 430 which may issue transactions, e.g., via a root port, to a fabric or other component on a path to its destination. Understand while shown at this high level in the embodiment of FIG. 4A, many variations and alternatives are possible.

Referring now to FIG. 4B, shown is a block diagram of a representative hardware circuit for decoding completions in accordance with an embodiment. As illustrated, decoder circuit 450 may be implemented within a root port and configured to handle incoming completions with the encoding described herein. More specifically, incoming completions (and other incoming transactions) are received by a downstream receiver 460 configured to receive transactions from a downstream agent. In some cases, downstream receiver 460 may be configured to identify a completion (for a non-posted transaction) received among various types of incoming transactions and decode a header of the completion in a decoder 470. In various embodiments, decoder 470 may effectively reverse the encoding applied in encoder circuit 400. More specifically, upon identification of a reserved root bus ID within a requester ID of the transaction ID of the completion, decoder 470 may decode device and function fields of the requester ID and tag field to determine a source of the original non-posted request and send the request to this destination (namely the original source of the original non-posted request). In this way, the completion is appropriately handled without use of a tracking structure in the root complex. In an embodiment, decoder 470 may include logic gates, combinational logic, and/or other circuitry to effect a decoding of a transaction identifier received as part of a completion as above in Table 1 (for example).

Note that the decoding performed may cause the completion to be sent to the requester with the original identifying information of the request (e.g., core ID and core tracker ID information) in a header. In an embodiment, the completion is sent as a PCIe transaction if a peer-directed completion and as a native core-level response to a core if a core-directed completion. As further shown in FIG. 4B, downstream receiver 460 may direct transactions other than completions via a bypass path to an upstream transmitter 480, which may send transactions on a path to a destination. Understand while shown at this high level in the embodiment of FIG. 4B, many variations and alternatives are possible.

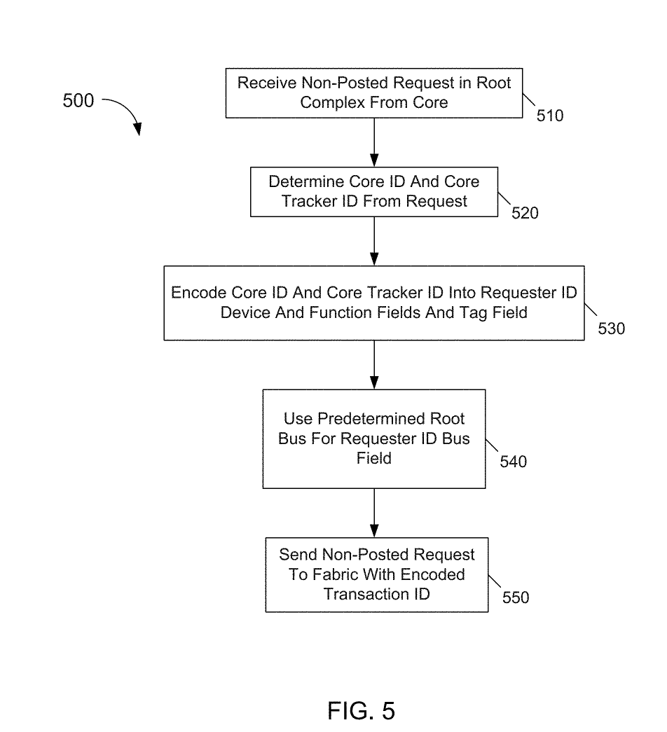

Referring now to FIG. 5, shown is a flow diagram of a method in accordance with an embodiment of the present invention. More specifically, FIG. 5 may be implemented in logic, such as encoder circuit 400 of FIG. 4A. As illustrated, method 500 begins by receiving a non-posted request in a root complex from a core (block 510). Next at block 520 from this request a core ID and a core tracker ID may be determined. Such information may be present, e.g., in a header of the received request. Then at block 530 this core ID and core tracker ID may be encoded into particular fields of a transaction ID. More specifically as shown, this information may be encoded into device and function fields of a requester ID and a tag field. In different implementations, different bits or portions of fields may be used to encode the source (requester) information. In some cases, a system may provide for non-posted request handling for transactions received from multiple source types, including cores and peers. In such cases, the encoding at block 530 may further include an initiator indicator into one or more of device and function fields of the requester ID and tag field, to indicate the request as originating from a core or peer. As an example, a single bit of one of these fields can be set at a first value (e.g., logic 1) to identify a core-initiated request and at a second value (e.g., logic 0) to identify a peer-initiated request. In systems in which the processing herein is to be applied only to core-initiated requests, this field may be optional (or not present).

Still further with reference to FIG. 5, at block 540 a predetermined root bus can be used for the bus field of the requester ID, namely a reserved root bus ID. Thereafter at block 550 the non-posted request can be sent to a fabric with this encoded transaction ID. Understand while shown at this high level in the embodiment of FIG. 5, many variations and alternatives are possible.

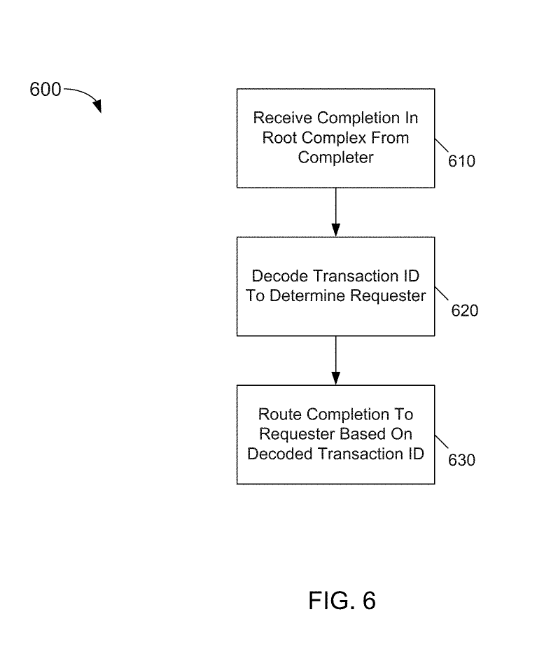

Referring now to FIG. 6, shown is a flow diagram of a method in accordance with another embodiment of the present invention. As shown in FIG. 6, method 600 may be may be implemented in logic, such as decoder circuit 450 of FIG. 4B. As illustrated, method 600 begins by receiving a completion in a root complex from a completer (block 610). This completion may provide, e.g., requested data of a read request by a core for such data. At block 620, the transaction ID can be decoded to determine the identity of the requester. Note that the decoding, which may be performed in hardware decode logic, can leverage the information present in the device and function fields of the requester ID and the tag field to determine the requester and various requester-provided information regarding the request. Accordingly, at block 630 the completion may be routed to the requester based on this decoded transaction ID to enable the requester to associate the completion with the original request. Understand while shown at this high level in the embodiment of FIG. 6, many variations and alternatives are possible.

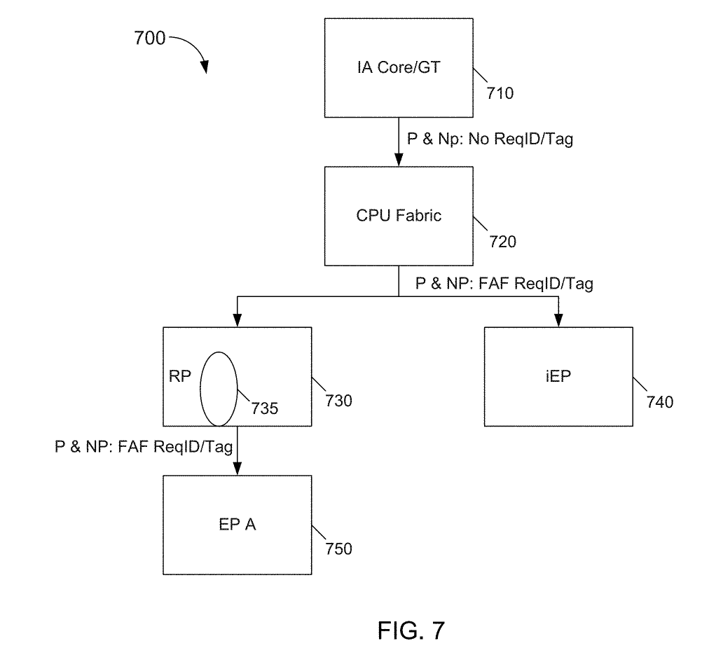

Referring now to FIG. 7, shown is a high level block diagram of a system in accordance with an embodiment. More specifically, system 700 may be a server computer including one or more processor sockets. Specifically shown in FIG. 7, at least some of the components may be implemented within the processor socket, while other components may be separate integrated circuits or other components. However, for ease of illustration of the non-posted transaction flow processing, distinctions as to a socket boundary are not shown in FIG. 7.

Assume a core-initiated read request is generated in a given core 710. Understand that this core may be any type of general-purpose processor, graphics processor or so forth. As an example, assume that core 710 is an Intel Architecture™ core, e.g., a 64-bit core. As seen, core 710 issues a non-posted read request (and posted requests) with no requester ID or tag, as such core is not a PCIe device.

In turn, such requests are received in a fabric 720, which may be a CPU fabric (e.g., a PCIe fabric). Fabric 720 may include a root complex or other circuitry configured to perform the non-posted transaction encoding as described herein. As such, CPU fabric 720 may encode a transaction identifier to include a fire and forget (FAF) requester ID and tag as described herein, in some cases for both posted and non-posted requests. As such, when this transaction is issued through other components, including a root port 730 including an internal logic 735 and from there to an endpoint 750 (or directly to an integrated endpoint 740), such FAF requester ID and tag of the transaction ID may be used to enable a completion to be generated and sent back to CPU fabric 720. This is in contrast to conventional PCIe processing, in which CPU fabric 720 would insert its internal function's requester ID and tag onto the transaction (and associate an internal tracker structure entry for such transaction). As such, when the completion is received in fabric 720 decoding may be performed to enable the originally encoded transaction ID to be obtained and used to route the completion back to core 710.

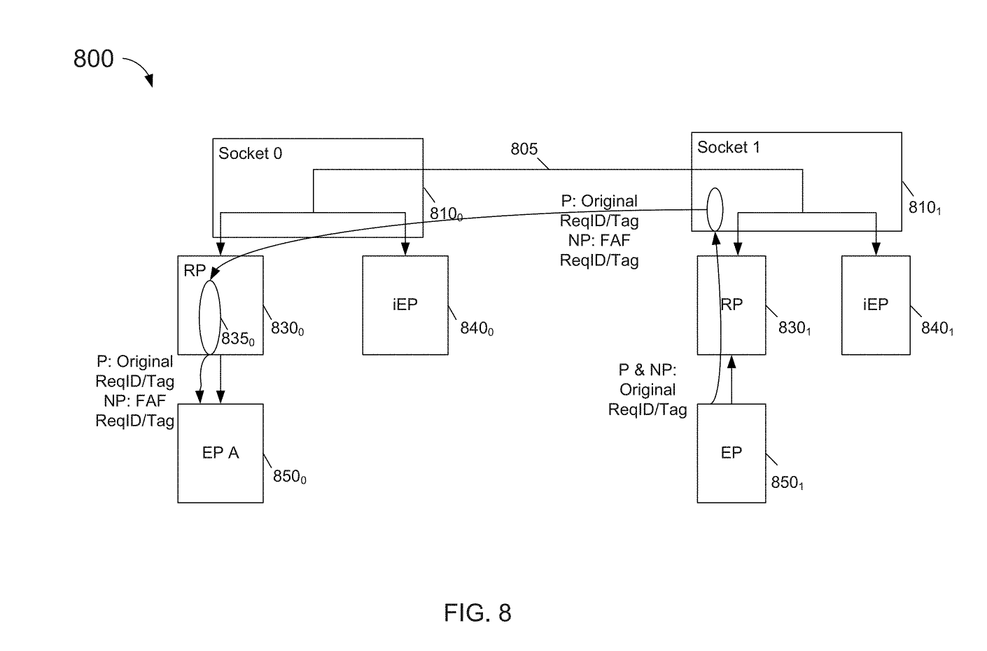

FIG. 8 is a high level block diagram of a multi-socket server 800 with multiple sockets 810₀ and 810₁ coupled together via a uni-port interconnect 805. In addition, each socket 810 is associated with a corresponding root port 830₀-830₁ (including internal circuitry 835₀-835₁), an integrated endpoint 840₀-840₁, and an endpoint 850₀-850₁, coupled to corresponding root ports 830.

FIG. 8 illustrates an implementation in which a peer-initiated request from endpoint 850₁ is to be communicated to endpoint 850₀. When this peer-initiated transaction is received in socket 810₁, internal logic encodes information from the received non-posted request into a FAF requester ID and tag, to enable correct handling downstream and receipt of a completion, without reserving an entry in a tracker storage of socket 810₁. As such, this handling of non-posted transactions differs from conventional PCIe processing, in which an original transaction ID as generated in endpoint 850₁ remains with the transaction, until its handling in root port 830 when a root port bus address (not a reserved bus address as described herein) would be applied to the transaction, to enable proper handling, including storage in a tracker entry structure of this receiving root port.

One interconnect fabric architecture includes the PCIe architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

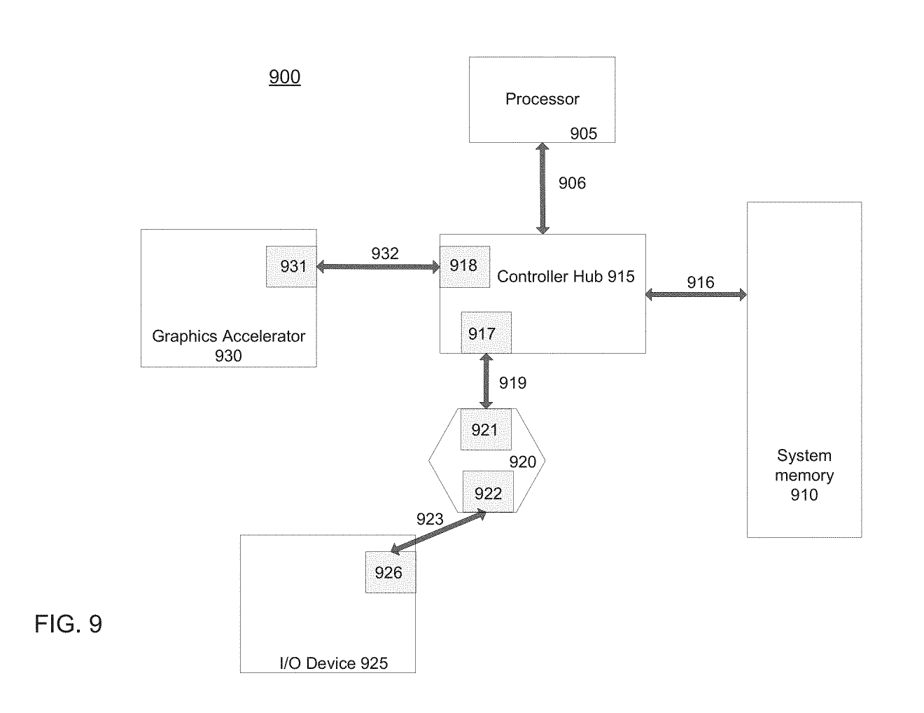

Referring to FIG. 9, an embodiment of a fabric composed of point-to-point links that interconnect a set of components is illustrated. System 900 includes processor 905 and system memory 910 coupled to controller hub 915. Processor 905 includes any processing element, such as a microprocessor, a host processor, an embedded processor, a co-processor, or other processor. Processor 905 is coupled to controller hub 915 through front-side bus (FSB) 906. In one embodiment, FSB 906 is a serial point-to-point interconnect as described below. In another embodiment, link 906 includes a serial, differential interconnect architecture that is compliant with different interconnect standard.

System memory 910 includes any memory device, such as random access memory (RAM), non-volatile (NV) memory, or other memory accessible by devices in system 900. System memory 910 is coupled to controller hub 915 through memory interface 916. Examples of a memory interface include a double-data rate (DDR) memory interface, a dual-channel DDR memory interface, and a dynamic RAM (DRAM) memory interface.

In one embodiment, controller hub 915 is a root hub, root complex, or root controller in a PCIe interconnection hierarchy. Examples of controller hub 915 include a chip set, a memory controller hub (MCH), a northbridge, an interconnect controller hub (ICH), a southbridge, and a root controller/hub. Often the term chip set refers to two physically separate controller hubs, i.e. a memory controller hub (MCH) coupled to an interconnect controller hub (ICH). Note that current systems often include the MCH integrated with processor 905, while controller 915 is to communicate with I/O devices, in a similar manner as described below. In some embodiments, peer-to-peer routing is optionally supported through root complex 915. Root complex 915 (and other circuits) may perform the transaction identifier-based encoding/decoding described herein.

Here, controller hub 915 is coupled to switch/bridge 920 through serial link 919. Input/output modules 917 and 921, which may also be referred to as interfaces/ports 917 and 921, include/implement a layered protocol stack to provide communication between controller hub 915 and switch 920. In one embodiment, multiple devices are capable of being coupled to switch 920.

Switch/bridge 920 routes packets/messages from device 925 upstream, i.e., up a hierarchy towards a root complex, to controller hub 915 and downstream, i.e., down a hierarchy away from a root controller, from processor 905 or system memory 910 to device 925. Switch 920, in one embodiment, is referred to as a logical assembly of multiple virtual PCI-to-PCI bridge devices. Device 925 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such a device is referred to as an endpoint. Although not specifically shown, device 925 may include a PCIe to PCI/PCI-X bridge to support legacy or other version PCI devices. Endpoint devices in PCIe are often classified as legacy, PCIe, or root complex integrated endpoints.

Graphics accelerator 930 is also coupled to controller hub 915 through serial link 932. In one embodiment, graphics accelerator 930 is coupled to an MCH, which is coupled to an ICH. Switch 920, and accordingly I/O device 925, is then coupled to the ICH. I/O modules 931 and 918 are also to implement a layered protocol stack to communicate between graphics accelerator 930 and controller hub 915. A graphics controller or the graphics accelerator 930 itself may be integrated in processor 905.

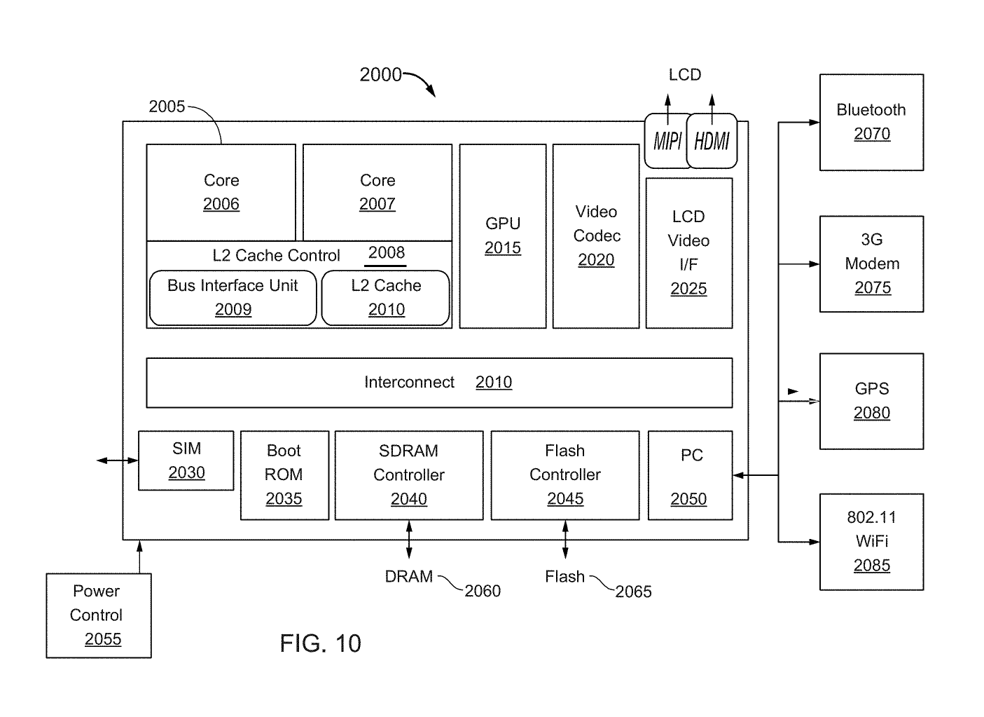

Turning next to FIG. 10, an embodiment of a SoC design in accordance with an embodiment is depicted. As a specific illustrative example, SoC 2000 may be configured for insertion in any type of computing device, ranging from portable device to server system. Here, SoC 2000 includes 2 cores—2006 and 2007. Similar to the discussion above, cores 2006 and 2007 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 2006 and 2007 are coupled to cache control 2008 that is associated with bus interface unit 2009 and L2 cache 2010 to communicate with other parts of system 2000. Interconnect 2010 includes an on-chip interconnect, and may implement transaction identifier encoding/decoding as described herein.

Interconnect 2010 provides communication channels to the other components, such as a Subscriber Identity Module (SIM) 2030 to interface with a SIM card, a boot ROM 2035 to hold boot code for execution by cores 2006 and 2007 to initialize and boot SoC 2000, a SDRAM controller 2040 to interface with external memory (e.g., DRAM 2060), a flash controller 2045 to interface with non-volatile memory (e.g., Flash 2065), a peripheral controller 2050 (e.g., an eSPI interface) to interface with peripherals, video codecs 2020 and Video interface 2025 to display and receive input (e.g., touch enabled input), GPU 2015 to perform graphics related computations, etc. Any of these interfaces may incorporate aspects described herein. In addition, the system illustrates peripherals for communication, such as a Bluetooth module 2070, 3G modem 2075, GPS 2080, and WiFi 2085. Also included in the system is a power controller 2055.

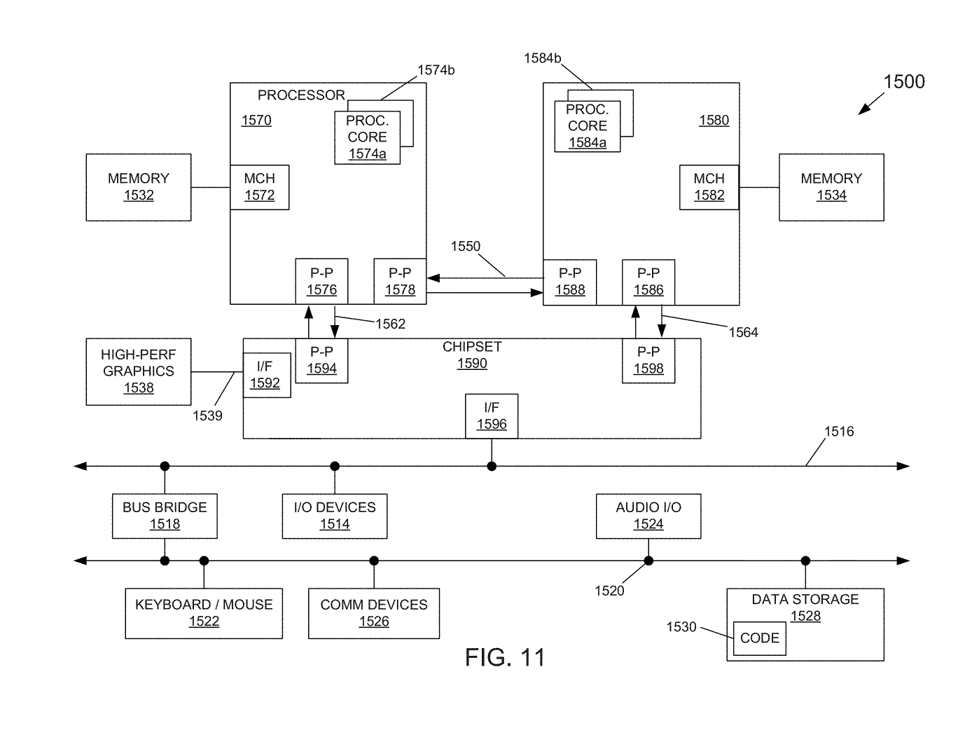

Referring now to FIG. 11, shown is a block diagram of a system in accordance with an embodiment of the present invention. As shown in FIG. 11, multiprocessor system 1500 includes a first processor 1570 and a second processor 1580 coupled via a point-to-point interconnect 1550. As shown in FIG. 11, each of processors 1570 and 1580 may be many core processors including representative first and second processor cores (i.e., processor cores 1574a and 1574b and processor cores 1584a and 1584b).

Still referring to FIG. 11, first processor 1570 further includes a memory controller hub (MCH) 1572 and point-to-point (P-P) interfaces 1576 and 1578. Similarly, second processor 1580 includes a MCH 1582 and P-P interfaces 1586 and 1588. As shown in FIG. 11, MCH's 1572 and 1582 couple the processors to respective memories, namely a memory 1532 and a memory 1534, which may be portions of system memory (e.g., DRAM) locally attached to the respective processors. First processor 1570 and second processor 1580 may be coupled to a chip set 1590 via P-P interconnects 1562 and 1564, respectively. As shown in FIG. 11, chipset 1590 includes P-P interfaces 1594 and 1598.

Furthermore, chipset 1590 includes an interface 1592 to couple chipset 1590 with a high performance graphics engine 1538, by a P-P interconnect 1539. Chipset 1590 may incorporate one or more root complexes to perform the encoding/decoding described herein, without the need for reserving tracker entries for non-posted transactions. In turn, chipset 1590 may be coupled to a first bus 1516 via an interface 1596. As shown in FIG. 11, various input/output (I/O) devices 1514 may be coupled to first bus 1516, along with a bus bridge 1518 which couples first bus 1516 to a second bus 1520. Various devices may be coupled to second bus 1520 including, for example, a keyboard/mouse 1522, communication devices 1526 and a data storage unit 1528 such as a disk drive or other mass storage device which may include code 1530, in one embodiment. Further, an audio I/O 1524 may be coupled to second bus 1520.

In one example, an apparatus comprises: an encoder to receive a non-posted transaction from a requester and encode information of the non-posted transaction into an encoded transaction identifier having a predetermined root bus identifier reserved for non-posted transactions; and a first transmitter to send the non-posted transaction including the encoded transaction identifier to a fabric, to enable the non-posted transaction to be routed to a destination.

In an example, the apparatus comprises a root complex.

In an example, the root complex is to receive and send the non-posted transaction to the fabric without reservation of a tracker entry in the root complex for the non-posted transaction.

In an example, the predetermined root bus identifier is reserved by a basic input/output system, the predetermined root bus identifier associated with the root complex, the root complex further associated with at least a second root bus identifier to be used for posted transactions.

In an example, the apparatus further comprises a decoder to receive a completion for the non-posted transaction and decode a transaction identifier of the completion to identify the requester.

In an example, the apparatus further comprises a second transmitter to send the completion to the requester, the second transmitter coupled to the decoder.

In an example, the encoder is to encode a source identifier of the information of the non-posted transaction into one or more of a device field and a function field of a requester identifier of the encoded transaction identifier and a tag field of the encoded transaction identifier.

In an example, the encoder is to encode the source identifier of the information of the non-posted transaction into at least a portion of the device field of the encoded transaction identifier.

In an example, the encoder is to encode a source tracker identifier of the information of the non-posted transaction into at least a portion of the tag field of the encoded transaction identifier.

In an example, the encoder is to encode a first indicator of the encoded transaction identifier with a first value when the non-posted transaction is a core-initiated request and encode the first indicator of the encoded transaction identifier with a second value when the non-posted transaction is a peer-initiated request.

In an example, the encoder is to receive and encode a transaction identifier of plurality of non-posted transactions from the requester, each of the plurality of non-posted transactions having a different device field value and a different function field value in the encoded transaction identifier.

Note that the above apparatus that may be a processor that can be implemented using various means. In one example, the processor comprises a SoC incorporated in a user equipment touch-enabled device. In another example, a system comprises a display and a memory, and includes the processor of one or more of the above examples.

In another example, a method comprises: receiving a non-posted request in a root complex from a core of a processor; encoding a core identifier and a tracker identifier of the non-posted request into at least two of a device field, a function field and a tag field of a transaction identifier; applying a predetermined root bus value to a bus field of the transaction identifier; and sending the non-posted request having the transaction identifier to a fabric.

In an example, the method further comprises receiving the non-posted request and sending the non-posted request to the fabric without reservation of a tracker entry in the root complex for the non-posted request.

In an example, the method further comprises reserving the predetermined root bus value for non-posted requests associated with the root complex, the root complex further associated with at least a second root bus identifier to be used for posted transactions.

In an example, the method further comprises receiving and encoding a plurality of non-posted requests from the requester, each of the encoded plurality of non-posted requests having a different device field value and a different function field value.

In an example, the method further comprises receiving a completion for the non-posted request and decoding a transaction identifier of the completion to identify the requester and sending the completion to the requester.

In an example, the method further comprises encoding a source identifier and a source tracker identifier of a peer-initiated non-posted request into at least two of a device field, a function field, and a tag field of a transaction identifier.

In another example, a computer readable medium including instructions is to perform the method of any of the above examples.

In another example, a computer readable medium including data is to be used by at least one machine to fabricate at least one integrated circuit to perform the method of any one of the above examples.

In another example, a system comprises a processor that in turn includes: a core to execute instructions; a root complex to interface the core to a fabric, the root complex comprising: an encoder to receive a non-posted transaction from the core and encode information of the non-posted transaction into an encoded transaction identifier having a predetermined root bus identifier reserved for non-posted transactions; a first transmitter to send the non-posted transaction including the encoded transaction identifier to the fabric; and a decoder to receive a completion for the non-posted transaction and decode a transaction identifier of the completion to identify the requester; and the fabric to receive and route the non-posted transaction including the encoded transaction identifier to a destination. The system may further include one or more endpoints coupled to the processor.

In an example, the root complex is to receive the non-posted transaction and send the non-posted transaction to the fabric without reservation of a tracker entry in the root complex for the non-posted transaction, the root complex not including a tracker structure.

In an example, the predetermined root bus identifier is reserved by a basic input/output system, the predetermined root bus identifier associated with the root complex, the root complex further associated with at least a second root bus identifier to be used for posted transactions.

In another example, an apparatus comprises: means for encoding information of a non-posted transaction received from a requester into an encoded transaction identifier having a predetermined root bus identifier reserved for non-posted transactions; and means for transmitting the non-posted transaction including the encoded transaction identifier to a fabric, to enable the non-posted transaction to be routed to a destination.

In an example, the apparatus comprises a root complex.

In an example, the root complex is to receive and send the non-posted transaction to the fabric without reservation of a tracker entry in the root complex for the non-posted transaction.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
an encoder to receive a non-posted transaction from a requester and encode information of the non-posted transaction into an encoded transaction identifier having a predetermined root bus identifier reserved for non-posted transactions; and
a first transmitter to send the non-posted transaction including the encoded transaction identifier to a fabric, to enable the non-posted transaction to be routed to a destination.

2. The apparatus of claim 1, wherein the apparatus comprises a root complex.

3. The apparatus of claim 2, wherein the root complex is to receive and send the non-posted transaction to the fabric without reservation of a tracker entry in the root complex for the non-posted transaction.

4. The apparatus of claim 2, wherein the predetermined root bus identifier is reserved by a basic input/output system, the predetermined root bus identifier associated with the root complex, the root complex further associated with at least a second root bus identifier to be used for posted transactions.

5. The apparatus of claim 1, further comprising a decoder to receive a completion for the non-posted transaction and decode a transaction identifier of the completion to identify the requester.

6. The apparatus of claim 5, further comprising a second transmitter to send the completion to the requester, the second transmitter coupled to the decoder.

7. The apparatus of claim 1, wherein the encoder is to encode a source identifier of the information of the non-posted transaction into one or more of a device field and a function field of a requester identifier of the encoded transaction identifier and a tag field of the encoded transaction identifier.

8. The apparatus of claim 7, wherein the encoder is to encode the source identifier of the information of the non-posted transaction into at least a portion of the device field of the encoded transaction identifier.

9. The apparatus of claim 7, wherein the encoder is to encode a source tracker identifier of the information of the non-posted transaction into at least a portion of the tag field of the encoded transaction identifier.

10. The apparatus of claim 7, wherein the encoder is to encode a first indicator of the encoded transaction identifier with a first value when the non-posted transaction is a core-initiated request and encode the first indicator of the encoded transaction identifier with a second value when the non-posted transaction is a peer-initiated request.

11. The apparatus of claim 7, wherein the encoder is to receive and encode a transaction identifier of plurality of non-posted transactions from the requester, each of the plurality of non-posted transactions having a different device field value and a different function field value in the encoded transaction identifier.

12. At least one computer readable storage medium comprising instructions that when executed enable a system to:
receive a non-posted request in a root complex from a core of a processor;
encode a core identifier and a tracker identifier of the non-posted request into at least two of a device field, a function field and a tag field of a transaction identifier;
apply a predetermined root bus value to a bus field of the transaction identifier; and
send the non-posted request having the transaction identifier to a fabric.

13. The at least one computer readable storage medium of claim 12, further comprising instructions that when executed enable the system to receive the non-posted request and send the non-posted request to the fabric without reservation of a tracker entry in the root complex for the non-posted request.

14. The at least one computer readable storage medium of claim 12, further comprising instructions that when executed enable the system to reserve the predetermined root bus value for non-posted requests associated with the root complex, the root complex further associated with at least a second root bus identifier to be used for posted transactions.

15. The at least one computer readable storage medium of claim 12, further comprising instructions that when executed enable the system to receive and encode a plurality of non-posted requests from the requester, each of the encoded plurality of non-posted requests having a different device field value and a different function field value.

16. The at least one computer readable storage medium of claim 12, further comprising instructions that when executed enable the system to receive a completion for the non-posted request and decode a transaction identifier of the completion to identify the requester and send the completion to the requester.

17. The at least one computer readable storage medium of claim 12, further comprising instructions that when executed enable the system to encode a source identifier and a source tracker identifier of a peer-initiated non-posted request into at least two of a device field, a function field, and a tag field of a transaction identifier.

18. A system comprising:
a processor comprising:
a core to execute instructions;
a root complex to interface the core to a fabric, the root complex comprising:
an encoder to receive a non-posted transaction from the core and encode information of the non-posted transaction into an encoded transaction identifier having a predetermined root bus identifier reserved for non-posted transactions;
a first transmitter to send the non-posted transaction including the encoded transaction identifier to the fabric; and
a decoder to receive a completion for the non-posted transaction and decode a transaction identifier of the completion to identify the requester; and
the fabric to receive and route the non-posted transaction including the encoded transaction identifier to a destination; and
one or more endpoints coupled to the processor.

19. The system of claim 18, wherein the root complex is to receive the non-posted transaction and send the non-posted transaction to the fabric without reservation of a tracker entry in the root complex for the non-posted transaction, the root complex not including a tracker structure.

20. The system of claim 18, wherein the predetermined root bus identifier is reserved by a basic input/output system, the predetermined root bus identifier associated with the root complex, the root complex further associated with at least a second root bus identifier to be used for posted transactions.
